(19) United States
(12) Patent Application Publication
(10) Pub. No.: US 2026/0162309 A1
(43) Pub. Date: Jun. 11, 2026

(54) LEARNING-BASED POINT CLOUD COMPRESSION VIA ADAPTIVE POINT GENERATION

(71) Applicant: InterDigital VC Holdings, Inc., Wilmington, DE (US)

(72) Inventors: Muhammad Asad LODHI, New York, NY (US); Jiahao PANG, New York, NY (US); Dong TIAN, Wilmington, DE (US)

(21) Appl. No.: 18/706,620

(22) PCT Filed: Oct. 17, 2022
(86) PCT No.: PCT/US2022/046916

§ 371 Date: May 1, 2024

Related U.S. Application Data
(60) Provisional application No. 63/275,477, filed on Nov. 4, 2021.

(51) Int. Cl. G06T 9/00

(52) U.S. Cl. CPC G06T 9/001; G06T 9/002

(57) ABSTRACT

In one implementation, we propose an adaptive point generation mechanism that can control the number of output points, for example, to have it matched exactly to the number of input points. The proposed method can be used in folding-based point cloud compression systems. In one example, using FPS (Farthest Point Sampling), we propose the adaptive grid generator, which provides control over the number of points in the reconstructed point cloud. Given an input point cloud, a pre-defined 2D grid is sampled using FPS procedure with the number of input points controlling the number of samples. On one hand, this enables lossless reconstruction of point clouds which is useful for storage and several real-world applications. On the other hand, having control over the number of output points also opens avenues to machine and vision applications such as hierarchical processing, super-resolution, summarization, of point clouds.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple ipad Pro 2020 and Intel RealSense LiDAR camera L515. With advances in sensing technologies, 3D point cloud data becomes more practical than ever and is expected to be an ultimate enabler in the applications discussed herein.

### SUMMARY

According to an embodiment, a method for decoding point cloud data is provided, comprising: decoding a codeword that provides a representation of a point cloud; decoding a number of samples, N; generating an adaptive point set having N samples; and reconstructing said point cloud responsive to said codeword and said adaptive point set, using a neural network-based module.

According to another embodiment, a method for encoding point cloud data is provided, comprising: generating a codeword, by a neural network-based module, which provides a representation of an input point cloud associated with said point cloud data; compressing said codeword; encoding a number of samples, N; generating an adaptive point set having N samples; and reconstructing a first point cloud, by another neural network-based module, based on said codeword and said adaptive point set.

According to another embodiment, an apparatus for decoding point cloud data is provided, comprising one or more processors, wherein said one or more processors are configured to decode a codeword that provides a representation of a point cloud; decode a number of samples, N; generate an adaptive point set having N samples; and reconstruct said point cloud responsive to said codeword and said adaptive point set, using a neural network-based module. The apparatus may further include at least one memory coupled to said more or more processors.

According to another embodiment, an apparatus for encoding point cloud data is provided, comprising one or more processors, wherein said one or more processors are configured to generate a codeword, by a neural network-based module, which provides a representation of an input point cloud associated with said point cloud data; compress said codeword; encode a number of samples, N; generate an adaptive point set having N samples; and reconstruct a first point cloud, by another neural network-based module, based on said codeword and said adaptive point set. The apparatus may further include at least one memory coupled to said more or more processors.

One or more embodiments also provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding point cloud data according to the methods described above.

One or more embodiments also provide a computer readable storage medium having stored thereon video data generated according to the methods described above. One or more embodiments also provide a method and apparatus for transmitting or receiving the video data generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of the FoldingNet.

FIG. 3 illustrates a block diagram of the FoldingNet with the proposed adaptive point generator, according to an embodiment.

FIG. 4 illustrates a block diagram of the proposed adaptive point generation, according to an embodiment.

FIG. 5 illustrates an adaptive FoldingCompression system with the proposed adaptive point generator, according to an embodiment.

FIG. 6 illustrates a TearingCompression system with the proposed adaptive point generator, according to an embodiment.

FIG. 7 illustrates an example of image interpolation and compression in TearingCompression with the proposed adaptive point generator, according to an embodiment.

FIG. 8 illustrates an example of neural-network based image interpolation and compression in TearingCompression with the proposed adaptive point generator, according to an embodiment.

FIG. 9 illustrates an example of Scalable Adaptive FoldingCompression with the proposed adaptive point generator, according to an embodiment.

FIG. 10 illustrates a method of encoding the point cloud data, according to an embodiment.

FIG. 11 illustrates a method of decoding the point cloud data, according to an embodiment.

### DETAILED DESCRIPTION

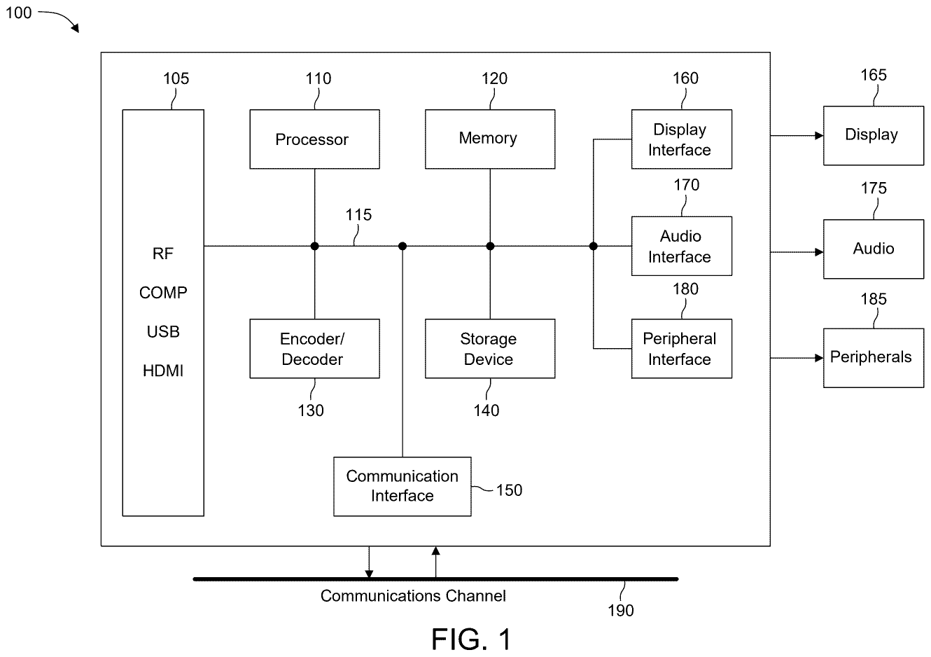

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-I, JPEG Pleno, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

In order to perform processing or inference on a point cloud, efficient storage methodologies are needed. To store and process an input point cloud with affordable computational cost, one solution is to down-sample the point cloud first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down-sampled) into a bitstream through entropy coding techniques for lossless compression. Better entropy models result in a smaller bitstream and hence more efficient compression. Additionally, the entropy models can also be paired with downstream tasks which allow the entropy encoder to maintain the task-specific information while compressing.

In addition to lossless coding, many scenarios seek lossy coding for significantly improved compression ratio while maintaining the induced distortion under certain quality levels.

### Folding-Based Point Cloud Generators/Decoders

Folding-based point cloud generators/decoders are one of the methods that explicitly utilize a hypothesis that the point clouds to be processed represent 2D surfaces/manifolds in 3D space. Hence, a 2D primitive is provided as input to the folding-based generator/decoder. To facilitate the implementation, the 2D primitive is sampled as a set of 2D grid.

### Existing 2D Grid Generator

In the following, for folding-based point cloud reconstruction architectures, e.g., FoldingNet, TearningNet, and TearningCompression, we describe the point generator on the decoding side of the architectures.

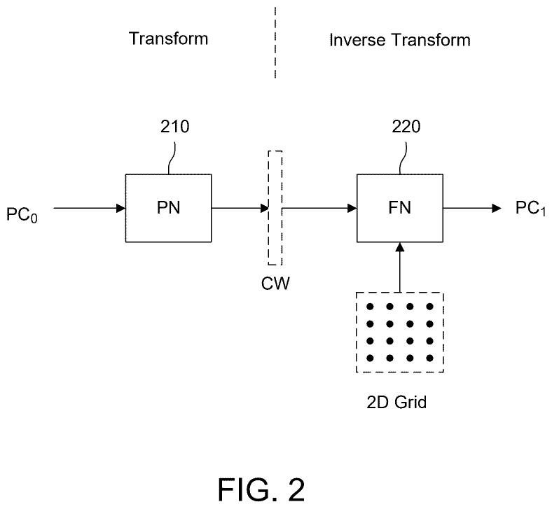

FIG. 2 shows a simplified diagram of the existing FoldingNet to highlight the transform (encoder) and the inverse transform (decoder). Note that we intentionally rename the encoder and decoder in the autoencoder as “transform” and “inverse transform,” respectively, to align the terms to the context of compression.

The inverse transform (decoder) makes use of a (fixed) point generator (not shown) always generating a 2D grid structure, which is essentially an image based on a pre-defined sampling pattern on a 2D surface. For each network instance, this grid is fixed and always produces the same number of points on the sampled surface. In one example, the sampled surface is a square region. In another example, it can be a sphere surface.

Given an original point cloud PC₀ (M points), the transforming module PN (210) generates a codeword CW in a latent space. Here, a latent space refers to an abstract multi-dimensional feature space, and the codeword CW is a feature vector representing the point cloud. Typically, the codeword can provide a high-level description or a rough representation of the point cloud.

The FN module (220) in the decoder then performs an inverse transforming process. It takes the 2D grid from the generator as an input in addition to the codeword CW, and endeavors to reconstruct a point cloud PCI which agrees with the codeword CW. The FN module (220) specifically maps each point on the 2D grid to one 3D point in the reconstructed point cloud. The point cloud output from the FN module, PC₁, contains N points, where N is not necessarily equal to M. Intuitively, the FN module “folds” the sampled points in a pre-defined 2D region to reconstruct various point clouds via an end-to-end training.

In the context of TearingNet and TearingCompression, one can again see the same two modules, point generator and FN module, interacting in a similar way with an additional TN module which transforms or “tears” the 2D grid. This tearing procedure has been shown to facilitate better reconstruction for multi-object codewords by adaptively displacing the points in the 2D grid.

For the 2D grid generator that is commonly utilized in the above folding-based point cloud generators/decoders, they always generate a fixed 2D grid point set at certain fixed resolution. This fixed 2D grid point set consists of 2D locations of points on a grid of certain (specified) resolution. The fixed number of 2D grid point determines the number of 3D points to be generated by the folding-based point cloud generator/decoder.

It is clear that the fixed 2D grid generator provides no way to control the number of output points. However, one may want to have the number of output points to match the input point clouds, e.g., in lossless reconstruction, or to manage the number of output points, e.g., in scalable reconstruction.

### Farthest Point Sampling (FPS)

Farthest point sampling (FPS) is one of the most used point cloud down-sampling approach. FPS is based on repeatedly choosing the next sample point in the least-explored area. Given a point cloud X and its sampled subset, the FPS algorithm chooses the farthest point to the sampled subset from the rest of the points in X with respect to Euclidean distance measure. This farthest point is then added to the subset. Here the subset is initialized by randomly picking a point from X. The FPS algorithm repeats this point selection process until a certain condition is met, e.g., the number of points in the subset reaches a pre-defined threshold. This classic sampling approach is deterministic and does not consider the downstream task.

### Proposed Adaptive Point Generator

A set of 2D points is used as input for folding-based point cloud decoders. Instead of using a fixed 2D grid point set, we propose an adaptive point generator. In one embodiment, a (continuous) 2D area is first defined, then we dynamically sample this 2D area to obtain a series of 2D points following the farthest point sampling (FPS) strategy. Note that in a 2D continuous area, there is no pre-defined grid, and samples can be drawn from any position in this area. Since the dynamic sampling process could be terminated any time, the number of 2D grid points and hence the number of reconstructed points could be precisely controlled. Note that the series of 2D points are ordered points according to their sampling index.

Consider a continuous 2D area from which samples can be drawn randomly. The goal of the FPS sampling method is to obtain samples in the unexplored/unsampled regions of the area under consideration. With this aim, FPS seeks to pick the next sample, given a set of already obtained samples, to always maximize the distance between the new point and all the points in the existing set. Ideally, if 2^{2N} samples are to be obtained in a 2D area, the end result should resemble a 2_{N}×2^{N} grid, where N is a positive integer. In the FPS procedure, the first sample can be chosen randomly, and subsequent samples are then based on this first sample's position.

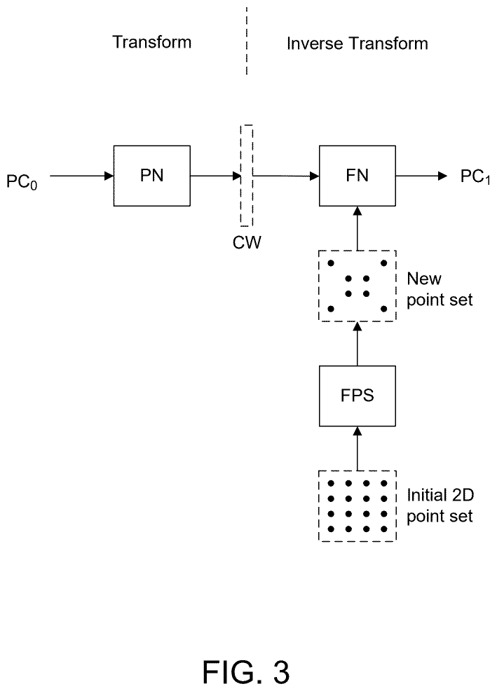

Consider now the enhanced versions of folding-based point cloud autoencoders (e.g., FoldingNet and TearningNet), where the pre-defined fixed 2D grid has been replaced with the proposed adaptive point generation, as shown in FIG. 3 for an example with FoldingNet. For the case of FoldingNet, the adaptive point set along with the codeword can now be used to perform a reconstruction of the input by exactly matching the number of input points to the number of points generated by the proposed generator. In a point cloud encoder/decoder framework, an additional integer would be required to be conveyed along with the codeword from the encoder to the decoder to signal the number of points in the input point cloud. Similarly, for TearingNet equipped by the proposed adaptive point generator, the number of generated points can be also managed.

In addition to exactly match the number of points to an input point cloud, folding-based point cloud decoders equipped with the proposed adaptive generator, can be used for hierarchical point cloud tasks such as hierarchical reconstruction. This can be achieved by signaling a series of increasing numbers of points to be reconstructed on the decoder side. Such a reconstruction mechanism can be particularly useful for tasks where the number of points needs to be precisely controlled e.g., visualization, summarization, key-point extraction, or super-resolution.

Above we described the adaptive point generation via an FPS sampling over a 2D area directly. Next, we present a few other alternative implementations.

### Large Pre-Defined Grid

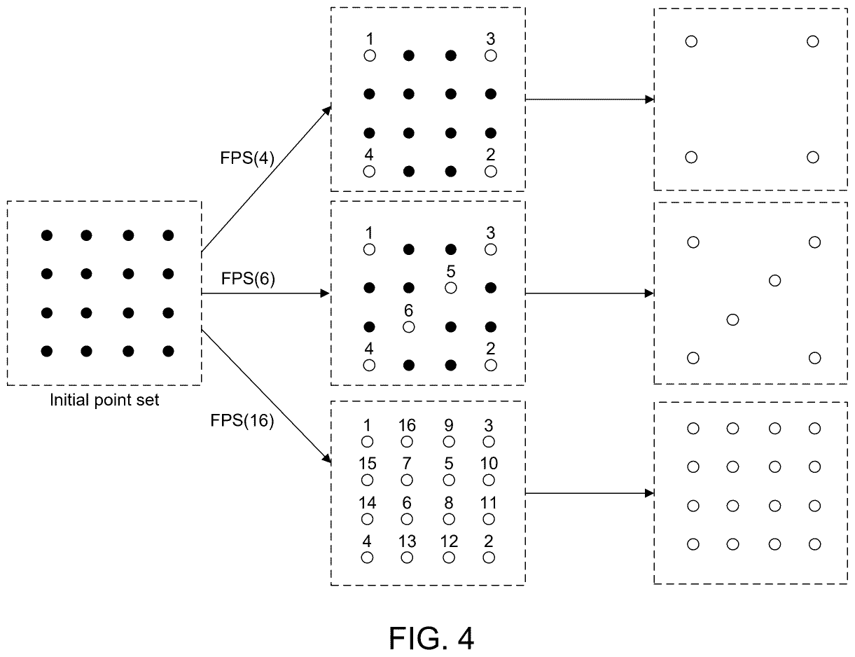

The mechanism of FPS based point generation can be simplified and accelerated by first generating a large pre-defined grid of size 2^{N}×2^{N}, and then adaptively selecting points from this grid in an FPS fashion. Here, N can be any large integer depending on the context. Examples of operation of the proposed generator are shown in FIG. 4 for several output settings, where 4, 6 and 16 points are generated from a 2²×2² pre-defined grid. When there are several samples that maximize the distance, any one sample can be chosen randomly. For example, from FIG. 4 in FPS(4), the sequence of samples could be 1, 2, 3, 4 or 1, 2, 4, 3. This is because 3 and 4 both maximize the distance. Either one can be chosen randomly.

### Bounding Grid

Another way to generate points for an input with N points can be to first generate an n×n grid, where n=ceil(sqrt(N)), ceil(x) representing the closest integer that is no smaller than x, and then use the proposed generator to pick N points on this grid as in the previous embodiment.

This is particularly useful with block-based point cloud processing (or compression) systems. As the number of points N in a block may be varying, it is desired to sample N points from a tightest grid with a resolution of n×n. It ensures a maximized coverage of 2D area and more uniformly distributed.

### Non-Square Grid

If the bounding box containing the underlying surface represented by the point cloud is a rectangular cuboid instead of a cube, it would be beneficial for the point generator to use this knowledge and adapt its output. Therefore, instead of a square shaped grid used in previous embodiments, a rectangular-shaped grid is used in this embodiment when the manifold or surface represented by the point cloud is not square-shaped.

Given an original point cloud with N points, an appropriately large initial 2D grid of size W×H is defined with M points such that W*H=M≥N. Then, the first N points out of these M points can be picked according to the FPS procedure so that the cardinality of the new point set, N, matches the input point cloud. The initial point in this point set is always fixed, and thus the resulting sampling pattern is always fixed for a particular value of N. This consistency of fixed sampling pattern for a particular N is useful for successful training of the folding-based architectures.

### Adaptive Density Grid

In previous embodiments, the FPS sampling strategy is solely controlled to maximize the coverage of the space. For non-uniformly scanned point clouds, the adaptive point generator can be further managed by a density distribution function. In one implementation, to determine the next sampling point, a score is proposed to be jointly assigned to all remaining points based on 1) its distance to the subset of points already being sampled, and 2) a specified density at its location. The assigned score is used to determine a probability for the associated point to be sampled.

The sampling density can be considered as a weight to be multiplied with the distance. For example, consider a 2D grid consisting of 4 quadrants: top left (TL), top right (TR), bottom left (BL), bottom right (BR). One example of density function could be: TL—0.4, TR—0.2, BL—0.2, BR—0.4. This means that the weight of a new point from a particular quadrant will be multiplied by its density function value when finding the points maximum distance apart. Doing this means more points will be picked from the regions with higher density value.

Once the possibility of being sampled is determined, one can use a random procedure to select the next one or multiple samples. One may prefer a pseudo-random process in order to repeat the exact same pattern between an encoder and a decoder.

Note that in this embodiment, we assume the density distribution along the 2D area is provided through external manners. For example, one can estimate the point density according to the torn-grid produced by a Tearing module as specified in TearingNet. The Tearing module takes a uniform grid and outputs a modified grid which has a non-uniform distribution with clusters of points with various densities depending on the objects in the scene. One can thus use this density information to inform the sampling density for the proposed adaptive point generator.

### Improved Folding-Based PCC

In the following, we will describe how the proposed point generator can be used in a point cloud compression system. We put forth enhanced versions of two existing folding-based compression systems, namely: FoldingCompression and TearingCompression. We also outline a block-based compression system for reduced complexity.

The proposed adaptive point generator can seamlessly replace the existing fixed 2D grid generator in any folding-based architecture. To achieve this, the proposed point generator is directly put in place of the existing 2D grid generator and an additional input indicating the number of output points is provided. As mentioned earlier, this provides a precise control over the number of points in the reconstruction from the folding-based decoder.

### Enhanced FoldingCompression

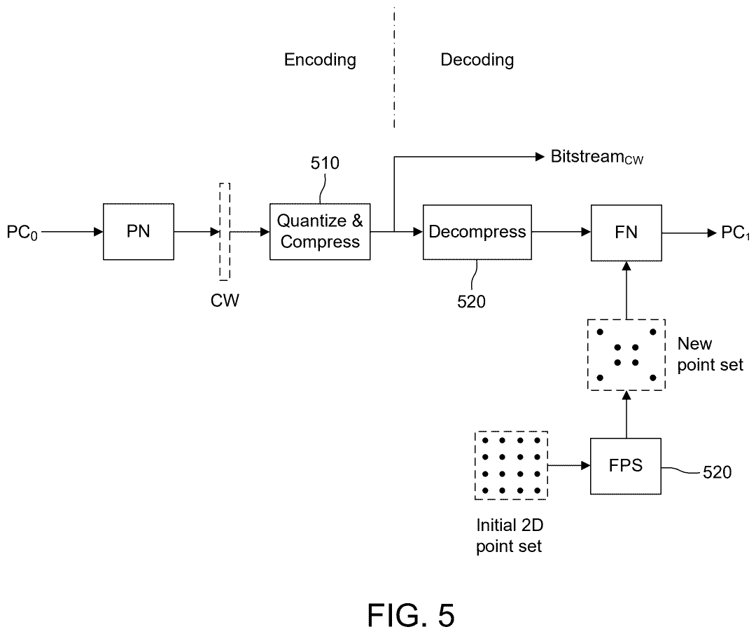

In this embodiment, it is proposed to apply the adaptive point generator in a learning-based point cloud compression system. The overall diagram of the proposed Adaptive FoldingCompression is shown in FIG. 5, according to an embodiment. The overall architecture is similar to FoldingNet, except for one difference. To facilitate decompression on different machines, the codeword produced from the proposed architecture is quantized and then compressed (510) into a bitstream (Bitstream_{CW}).

On the decoder side, the codeword is decoded (520) from the bitstream and is then used by the FN module in addition to the output of the proposed point generator. To control the number of output points in the reconstruction, an additional input indicating this number is required by the proposed adaptive point generator. This number can be transmitted within the bitstream along with the codeword as an extra high level syntax element, for example, via frame header, slice header, etc. If no such number is transmitted, the adaptive point generator (520) just outputs a pre-defined number of points. It should be noted that thanks to the proposed point generator the number of output points can now be the same, larger than, or smaller than the number of points in the input point cloud.

### Enhanced TearingCompression

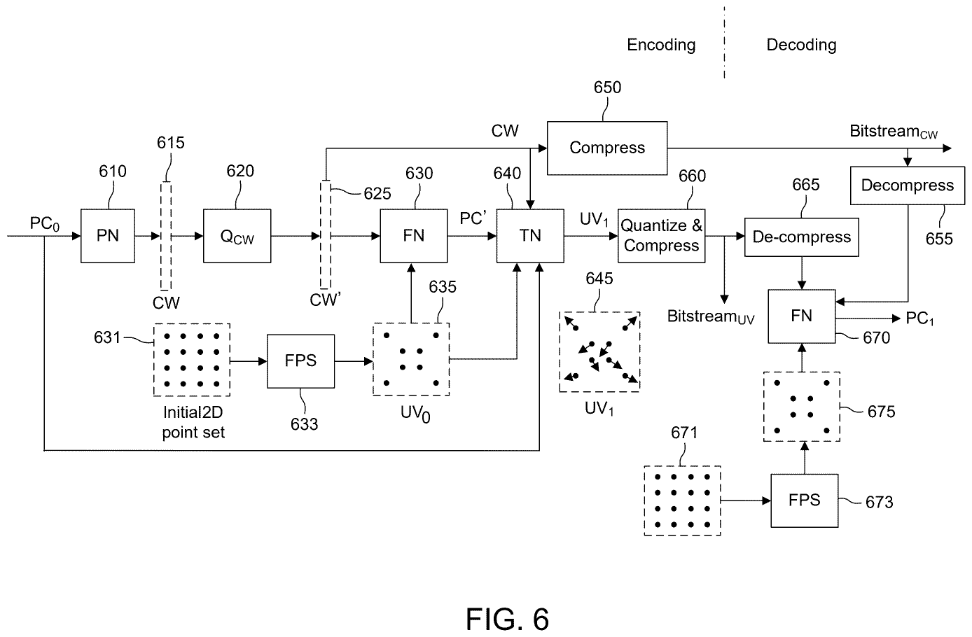

With the same rationale above, it is also proposed to introduce the adaptive point generator within the TearingCompression to form a point cloud compression system—an enhanced TearingCompression, as shown in FIG. 6, according to an embodiment. Here, compared with previous TearingCompression, different point generation methods (633, 673) are used.

In this embodiment, a PN module (610) takes input point cloud PC₀ as input, and generates a codeword CW (615). Then a quantization step (620, Q_{CW}) is applied on the codeword CW (615) to obtain quantized coded word CW′ (625), before it is fed to the FN module (630) during encoding. In the proposed compression system, in one example, CW′=rounding(CW/QS), where QS is a selected quantization step. One of the motivations for the quantization is to have the input to the FN module be exactly matched between the encoding and the decoding stages.

In parallel, an initial 2D point set (631) is input to the Farthest Point Sampling (FPS) module (633) which generates an adaptive grid 2D grid UV₀ (635). Then the codeword CW (625) and an adaptive grid image UV₀ (635, 2D grid) is fed to a FN module (630) that outputs a preliminary reconstruction of point cloud PC′. The TN module (640) then takes the adaptive grid image, PC′, PC₀ and CW as inputs, and generates an updated grid image UV₁ (645) as output. Then the codeword CW and grid image are compressed (650, 660) into bitstreams (Bitstreamcw, Bitstream_{UV}).

Compression of codeword CW can be a neural network-based module (650), such as a variational autoencoder based on a factorized prior model, which approximates the quantization operation by adding uniform noise.

In one embodiment, the compression (660) on the grid image (645) can be based on state-of-the-art image/video compression methods, e.g., JPEG, MPEG AVC/HEVC/VVC. Quantization (660) is performed before compression, for example, in order to convert the floating numbers in the grid image to a data format used by the 2D video encoder. In another embodiment, the compression (660) can be neural network-based methods, such as a variational autoencoder based on a factorized prior model or a scale hyperprior model, which approximates the quantization operation by adding uniform noise.

On the decoder side, the same procedure as the encoder is repeated on the initial 2D point set (671) through an FPS module (673) to obtain the same adaptive grid 2D grid UV₀ (675) as on the encoder side. Afterwards, the decoded codeword (655), the grid image (665), and the adaptive grid UV₀ (675) are used by the FN module (670) to reconstruct the point cloud PC₁.

Compared with the existing FoldingCompression system, a major difference is that the proposed point generator (633, 673) replaces the fixed 2D grid generator in both encoder and decoder. That is, the proposed adaptive point generator replaces the fixed 2D grid generator to produce an initial point set referred to as the initial UV₀ image (635, 675). Then the updated UV₁ image will follow the same point pattern as generated by the proposed point generator.

### Compression Considerations for Enhanced TearingCompression

Some aspects of introducing the proposed adaptive point generator in the TearingCompression framework need to be addressed. The updated UV₁ image, which is the output of TN module, is not amenable to standard image compression techniques as it can be sparse because of the FPS procedure, see FIG. 4 for examples. First, it should be pointed out that on the decoder side after the image is decoded, to obtain the sparse UV image one does not need to transmit any additional information like a mask of occupied point locations. The sparse image can be obtained by following the same FPS method (choosing the same initial sample point and subsequent sample points) used on the encoder side to generate the same pattern by just using the knowledge of the number of points in the input cloud, which can be transmitted in the bitstream along with the codeword. This is in contrast to other sparse coding techniques that require separate transmission of this mask.

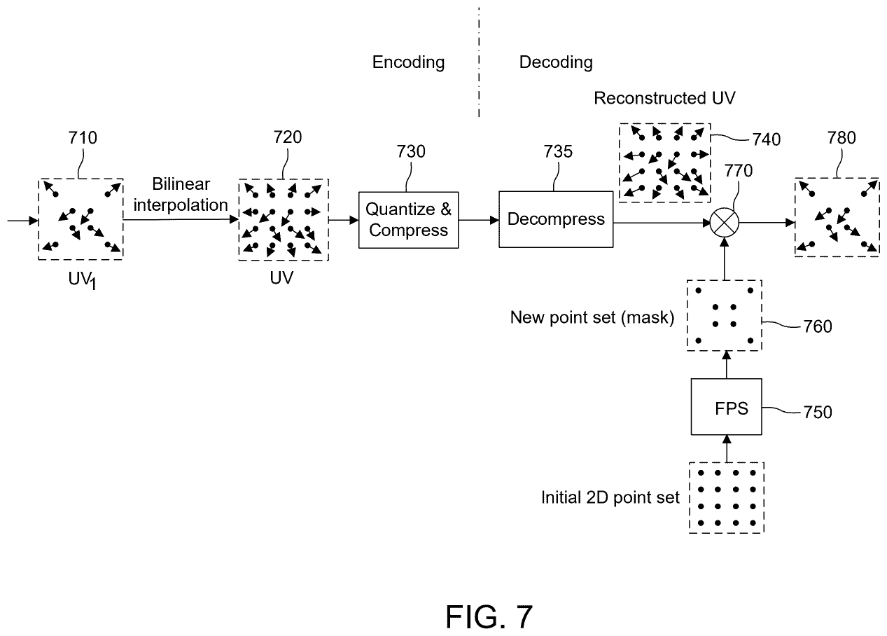

Secondly, to achieve efficient image compression of the UV₁ image, one can either use some basic techniques such as averaging or nearest neighbor matching to fill the empty pixels making the resulting image more suited for compression. The empty pixels in the UV₁ image however, which are filled on the encoder side, do not need to be considered even if they are decoded and can be discarded by following the same FPS procedure. A mask can be generated on decoder side by keeping the non-empty pixel locations from the output of FPS, and this mask can be used to keep the relevant pixels in the decoded UV₁ image. An example of UV₁ image compression (encoding then decoding) using bilinear interpolation is shown in FIG. 7. One can see that the sparse UV₁ image (710) is first processed through bilinear interpolation to fill the empty pixels and make the UV image (720). These filled pixels are such that they make the UV image uniform and smooth which is better for compression purposes. The UV image is then quantized and compressed (730) into a bitstream which is decoded (735) on the decoder side to obtain the UV image (740) again. To get back to the sparse UV₁ image, the FPS pattern from the encoder side is repeated (750) and a mask (760) is obtained for the non-empty pixel locations which can be applied (770) point-wise to the decoded UV image to obtain the reconstructed UV₁ image (780).

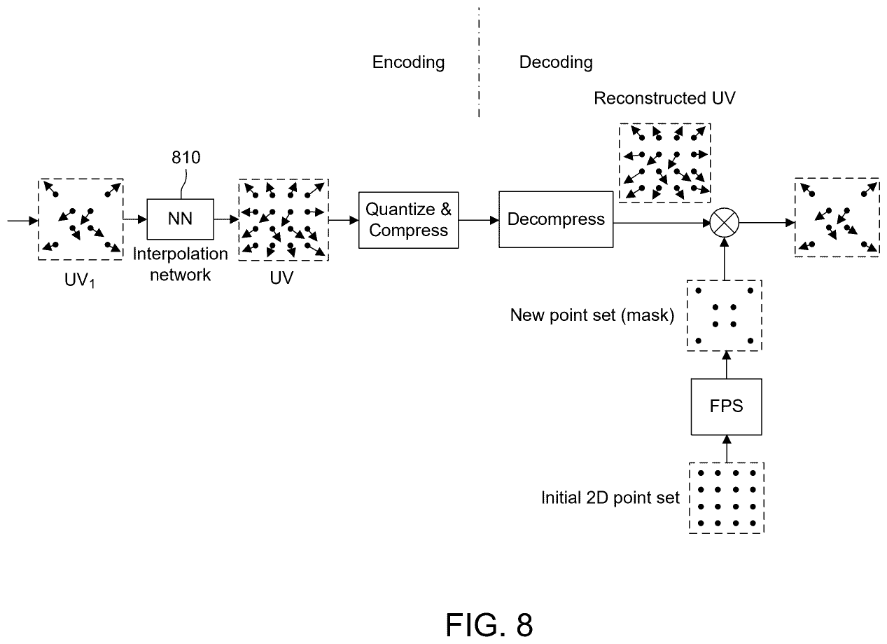

On the other hand, any of the existing learning-based architectures can also be used to either facilitate sparse image compression or do some image completion before the image is compressed. FIG. 8 shows an example with a generic neural-network module (810) where any existing learned based network can be plugged. The overall working of the architecture is the same as in FIG. 7, except for the neural network module (810) that replaces the bilinear interpolation to process the sparse UV₁ image. This neural network (810) can either be trained from scratch with the overall architecture or a pre-trained module can also be plugged in the pipeline.

### Block-Based PCC

In the above embodiments, the input point cloud to be encoded is a full point cloud frame. In another embodiment, it is proposed to first partition full point cloud frames into smaller point cloud blocks. Then the point cloud blocks are fed to the proposed architectures as inputs to limit the complexity required to process the input point clouds. In one example, the initial point is always chosen in the same manner for every block. A number of different ways can be applied for making blocks, and our method can work with any of them.

### Scalable Point Cloud Compression

To control the complexity during the reconstruction, the proposed point generator can also enable spatial scalable point cloud compression. To achieve this, on the encoder side, the bitstream can be organized in stages. Here each stage can correspond to an additional level of detail in the point cloud. On the decoder side, according to the desired application, the point cloud can be decoded in stages and the decoding can be stopped according to the required level of details; one does not need to decode the entire bitstream. Moreover, decoding of the later stages can also use the earlier decoded stages for prediction purposes.

### Point-Wise Scalable Point Cloud Compression

In one embodiment point wise scalability can be achieved by controlling the number of points required through the proposed generator.

### Group-Wise Scalable Point Cloud Compression

In another embodiment a coarser scalability can be achieved by adding groups of points (rather than individual points) in each successive stage of reconstruction.

Such scalable solutions can be used to achieve complexity scalability. As the number of decoded points increases, the complexity also increases. Clients with different computational capabilities can choose to decode different numbers of points.

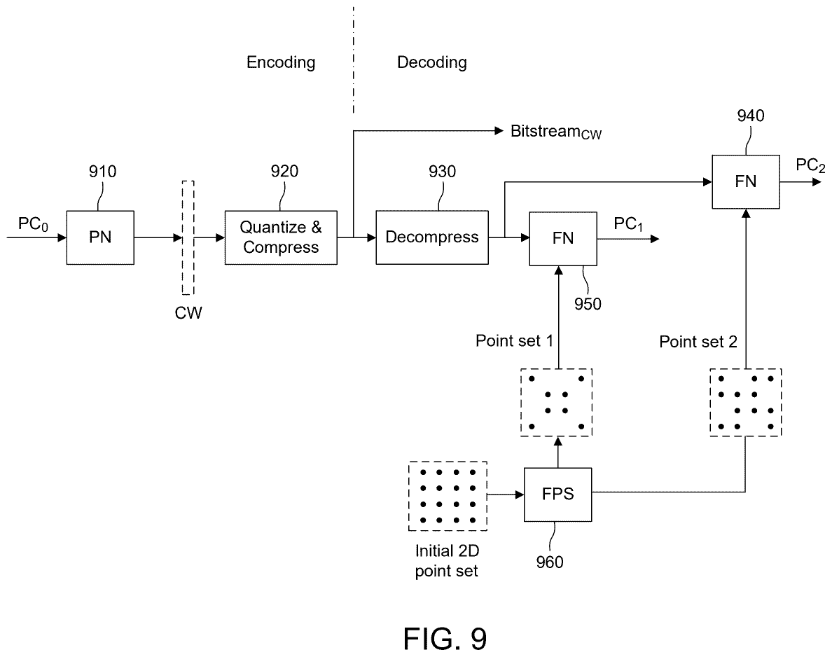

An example of group-wise scalable compression is depicted in FIG. 9. The encoder PN (910) encodes the point cloud as a codeword CW which is quantized and compressed (920) into a bitstream (Bitstreamcw). After this codeword is decompressed (930) on the decoder side, the FN (940, 950) takes several point sets (e.g., Point set 1, Point set 2), which are generated by the proposed point generator (960) using an initial 2D point set, each point set with an additional group of new points. The FN then uses these point sets to reconstruct the input point PC₀ with varying levels of details (e.g., PC₁, PC₂) depending on the number of points in each point set. Point-wise scalable compression follows simply by adding one point in each new group.

In the above, FPS is used as the sampling method to generate the adaptive point set (2D grid). It should be noted that any method that ensures coverage over the whole space being sampled can be used in place of FPS.

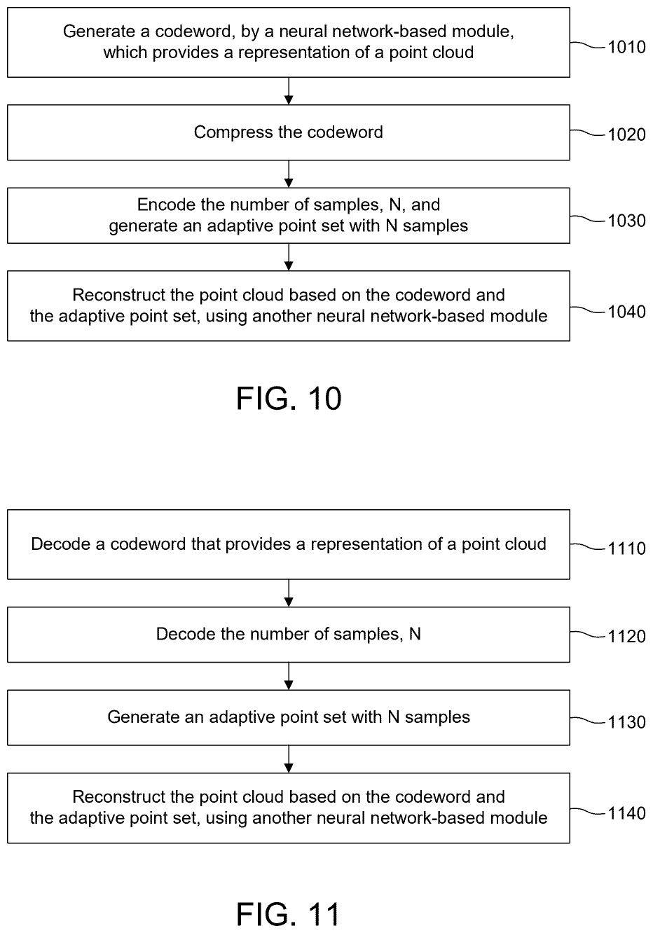

FIG. 10 illustrates a method of encoding point cloud data, according to an embodiment. In this embodiment, for a point cloud or a portion of point cloud (e.g., a point cloud block) to be encoded, the encoder generates (1010) a codeword to represent the point cloud, for example, by a neural network-based module. The encoder then compresses (1020) the codeword. The encoder also decides the number of points to be included in an adaptive point set. The encoder then generates (1030) the adaptive point set with N points, for example, with a Farthest Point Sampling (FPS) procedure, and encodes (1030) the number of points (N). Using another neural-network based module, for example, a FoldingNet, the encoder (1040) reconstructs the point cloud based on the codeword and the adaptive point set.

FIG. 11 illustrates a method of decoding point cloud data, according to an embodiment. In this embodiment, for a point cloud or a portion of point cloud (e.g., a point cloud block) to be decoded, the encoder decodes (1110) a codeword that represents the point cloud, for example, from at least a bitstream. The decoder then decodes (1120) the number of points (N) in an adaptive point set. The decoder then generates (1130) the adaptive point set with N points, for example, with a Farthest Point Sampling (FPS) procedure. Here the decoder uses the same method as the encoder side when generating the adaptive point set. Using a neural-network based module, for example, a FoldingNet, the decoder (1140) reconstructs the point cloud based on the codeword and the adaptive point set.

Various numeric values are used in the present application. The specific values are for example purposes and the aspects described are not limited to these specific values.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for decoding point cloud data, comprising:
decoding a codeword that provides a representation of a point cloud;
decoding a number of samples, N;
generating an adaptive point set having N samples; and
reconstructing said point cloud responsive to said codeword and said adaptive point set, using a neural network-based module.

2. The method of claim 1, further comprising:
obtaining another number of samples, N′;
generating another adaptive point set having N′ samples; and
reconstructing another version of said point cloud responsive to said codeword and said another point set, using said neural network-based module.

3-7. (canceled)

8. The method of claim 1, wherein said neural network-based module corresponds to a FoldingNet.

9. (canceled)

10. The method of claim 1, wherein a Farthest Point Sampling (FPS) procedure is used to generate said adaptive point set.

11-16. (canceled)

17. The method of claim 1, wherein samples for said adaptive point set are drawn from a grid of pre-defined size, further comprising:
accessing a density distribution function to obtain scores for samples in said adaptive point set, wherein said generating for samples subsequent to the first sample is based on distances and scores.

18-20. (canceled)

21. A method for encoding point cloud data, comprising:
generating a codeword, by a neural network-based module, which provides a representation of an input point cloud associated with said point cloud data;
compressing said codeword;
encoding a number of samples, N;
generating an adaptive point set having N samples; and
reconstructing a first point cloud, by another neural network-based module, based on said codeword and said adaptive point set.

22. The method of claim 21, further comprising:
adjusting said adaptive point set to generate another point set, by a third neural network-based module, based on said first reconstructed point cloud, said codeword, and said input point cloud.

23. The method of claim 22, further comprising:
compressing said another point set, wherein said another point set is for refining said representation of said input point cloud.

24. The method of claim 21, wherein said neural network-based module corresponds to a FoldingNet.

25. The method of claim 21, wherein a Farthest Point Sampling (FPS) procedure is used to generate said adaptive point set.

26. An apparatus for decoding point cloud data, comprising one or more processors and at least one memory coupled to said one or more processors, wherein said one or more processors are configured to: decode a codeword that provides a representation of a point cloud;
decode a number of samples, N;
generate an adaptive point set having N samples; and
reconstruct said point cloud responsive to said codeword and said adaptive point set, using a neural network-based module.

27. The apparatus of claim 26, wherein said one or more processors are further configured to:
obtain another number of samples, N′;
generate another adaptive point set having N′ samples; and
reconstruct another version of said point cloud responsive to said codeword and said another point set, using said neural network-based module.

28. The apparatus of claim 26, wherein said neural network-based module corresponds to a FoldingNet.

29. The apparatus of claim 26, wherein a Farthest Point Sampling (FPS) procedure is used to generate said adaptive point set.

30. The apparatus of claim 26, wherein samples for said adaptive point set are drawn from a grid of pre-defined size, wherein said one or more processors are further configured to:
access a density distribution function to obtain scores for samples in said adaptive point set, wherein said generating for samples subsequent to the first sample is based on distances and scores.

31. An apparatus for encoding point cloud data, comprising one or more processors and at least one memory coupled to said one or more processors, wherein said one or more processors are configured to:
generate a codeword, by a neural network-based module, which provides a representation of an input point cloud associated with said point cloud data;
compress said codeword;
encode a number of samples, N;
generate an adaptive point set having N samples; and
reconstruct a first point cloud, by another neural network-based module, based on said codeword and said adaptive point set.

32. The apparatus of claim 31, wherein said one or more processors are further configured to:
adjust said adaptive point set to generate another point set, by a third neural network-based module, based on said first reconstructed point cloud, said codeword, and said input point cloud.

33. The apparatus of claim 32, wherein said one or more processors are further configured to:
compress said another point set, wherein said another point set is for refining said representation of said input point cloud.

34. The apparatus of claim 31, wherein said neural network-based module corresponds to a FoldingNet.

35. The apparatus of claim 31, wherein a Farthest Point Sampling (FPS) procedure is used to generate said adaptive point set.
